(19) United States
(12) Patent Application Publication
(10) Pub. No.: US 2017/0269875 A1
(43) Pub. Date: Sep. 21, 2017

(54) MEMORY SYSTEM AND OPERATING METHOD THEREOF

(71) Applicant: SK hynix Inc., Gyeonggi-do (KR)

(72) Inventors: Sang-Yeon KIM, Gyeonggi-do (KR); Ki-Sun KIM, Gyeonggi-do (KR)

(21) Appl. No.: 15/236,226

(22) Filed: Aug. 12, 2016

(30) Foreign Application Priority Data
Mar. 17, 2016 (KR) 10-2016-0031977

(51) Int. Cl. G06F 3/06; G06F 12/06

(52) U.S. Cl. CPC G06F 3/0659; G06F 3/061; G06F 3/0683; G06F 12/0653; G06F 2212/1016

(57) ABSTRACT

A memory system includes a first memory device suitable for inputting and outputting data through a serial interface, a second memory device suitable for inputting and outputting the data through a parallel interface, and a controller suitable for detecting an access pattern of the data, selecting one of the first and the second memory devices based on the detected access pattern, and controlling the selected memory device to store the data.

### CROSS-REFERENCE TO RELATED APPLICATION

The present application claims priority under 35 U.S.C. §119(a) to Korean Patent Application No. 10-2016-0031977, filed on Mar. 17, 2016, which is incorporated herein by reference in its entirety.

### BACKGROUND

1. Field

Exemplary embodiments of the present invention relate generally to a memory system including a plurality of memory devices.

2. Description of the Related Art

A memory system is employed in several electronic devices for consumers or industry, for example, computers, mobile phones, portable digital assistants (PDAs), digital cameras, gaming machines, and navigators and is used as a main memory or an auxiliary memory. Memory devices for implementing a memory system include volatile memory devices, such as dynamic random access memory (DRAM) and static RAM (SRAM), and non-volatile memory devices, such as read only memory (ROM), mask ROM (MROM), programmable ROM (PROM), erasable programmable ROM (EPROM), electrically erasable programmable ROM (EEPROM), ferroelectric RAM (FRAM), phase-change RAM (PRAM), magnetoresistive RAM (MRAM), resistive RAM (RRAM), and flash memory.

A non-volatile memory device is advantageous in that the degree of integration is higher and consumes less power than a volatile memory device. However, generally, a non-volatile memory device has lower performance and write endurance than a volatile memory device. In order to make use of the advantages of both types of memory devices, hybrid memory systems have been proposed. A hybrid memory system may reduce or eliminate the disadvantages of the two types of memory devices, and may increase data stability by using a backup memory device even when sudden power interruption is generated. However, performance of hybrid memory systems may suffer due to a collision between the operations of the different type memory devices employed. Accordingly, there is a need for an improved hybrid memory system that is capable of reducing operational collision between the various memory devices employed in the hybrid memory system.

### SUMMARY

Various embodiments are directed to a memory system configured to detect an access pattern of data inputted to and output from at least two memory devices through a plurality of interfaces and to manage data stored in the memory devices based on the detected access pattern and an operating method thereof.

In an embodiment, a memory system may include: a first memory device suitable for inputting and outputting data through a serial interface; a second memory device suitable for inputting and outputting the data through a parallel interface; and a controller suitable for detecting an access pattern of the data, selecting one of the first and the second memory devices based on the detected access pattern, and controlling the selected memory device to store the data.

In another embodiment, a memory system may include: a first memory device suitable for inputting and outputting data through a serial interface; a second memory device suitable for inputting and to outputting the data through a parallel interface; and a controller suitable for configuring address mapping information of the data stored in the first and the second memory devices, wherein the controller is suitable for detecting an access pattern of the data for a specific time frame and performing an update on the address mapping information based on the detected access pattern.

In another embodiment, an operating method of a memory system may include storing data in a first memory device by sending the data through a serial interface and storing the data in a second memory device by sending the data through a parallel interface; configuring address mapping information of the data stored in the first and the second memory devices; detecting an access pattern of the data; and performing an update on the address mapping information based on the detected access pattern.

### BRIEF DESCRIPTION OF THE DRAWINGS

The above and other features and advantages of the present invention will become more apparent to those skilled in the art to which the present invention belongs by describing in detail various embodiments thereof with reference to the attached drawings in which:

FIG. 1 is a block diagram schematically showing a memory system, according to an embodiment of the present invention.

FIG. 2 is a block diagram showing a controller of FIG. 1.

FIG. 3 is a waveform illustrating an operation of a pattern detection unit of FIG. 2.

FIG. 4 is a diagram illustrating an operation of an address map configuration unit of FIG. 2.

FIG. 5 is a flowchart illustrating an overall operation of a memory system, according to an embodiment of the present invention.

### DETAILED DESCRIPTION

Various embodiments will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Unless otherwise defined, all terms including technical and scientific terms used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the specification and the relevant art and will not be interpreted in an idealized or overly formal sense unless expressly so defined herein.

The present invention may have diverse modifications and embodiments, and herein, the embodiments are taken as examples to describe the present invention. However, it is obvious to those skilled in the art that the described embodiments do not limit the scope of the present invention. Also, the constituent elements of the embodiments of the present invention should be understood to include all modifications substitutes and equivalents falling within the scope of the invention.

It will be understood that, although the terms “first” “second”, “third”, and so on may be used herein to describe various elements these elements are not limited by these terms. These terms are used to distinguish one element from another element Thus, a first element described below could also be termed as a second or third element without departing from the spirit and scope of the present invention.

It will be further understood that when an element is referred to as being “connected to” or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention. As used herein, singular forms are intended to include the plural forms as well, unless the context clearly indicates otherwise. It will be further understood that the terms “comprises”, “comprising”, “includes”, and “including” when used in this specification, specify the presence of the stated elements and do not preclude the presence or addition of one or more other elements. As used herein, the term “and/or” includes any and all combinations of one or more of the associated listed items.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

In some instances, as would be apparent to one of ordinary skill in the art elements described in connection with a particular embodiment may be used singly or in combination with other embodiments unless otherwise specifically indicated.

Hereinafter, the various embodiments of the present invention will be described in detail with reference to the attached drawings.

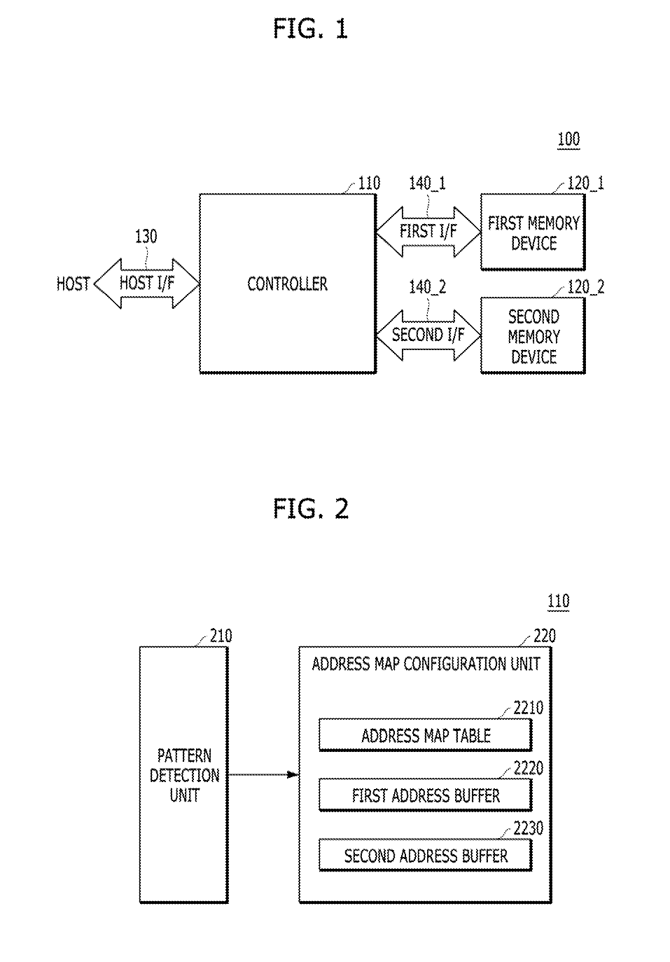

FIG. 1 is a block diagram schematically showing a memory system 100, according to an embodiment of the present invention.

Referring to FIG. 1, the memory system 100 includes a controller 110 and first and second memory devices 120_1 and 120_2. It is noted that although only two memory devices are employed in the illustrated embodiment of FIG. 1, in other embodiments more than two memory devices may be employed,

The controller 110 of the memory system 100 may store data, in the first and second memory devices 120_1 and 120_2 and manage the stored data. The data may be received from the host 130. The stored data may &so be accessed by the host 130. The controller 110 may control the exchange of the data with the host through a host interface (I/F) 130 based on one or more host interface protocols. In an embodiment, the controller 110 may control the exchange of the data with the host through a host interface (I/F) 130 based on a single host interface protocol. Furthermore, the controller 110 may exchange data, accessed by the host, with the first and the second memory devices 120_1 and 120_2 through first and second memory interfaces (I/Fs) 140_1 and 140_2.

The first memory interface I/F 140_1 may be a parallel I/F having a plurality of signal lines through which commands, addresses, and data are respectively transmitted. The second I/F 140_2 may be a serial I/F through which commands, addresses, and data are packetized and transmitted. Compared to the parallel I/F, the serial I/F may transmit a large amount of data at a time, but may have long latency because it requires packetization/depacketization operations before transmitting a packet and after receiving the packet. That is, a packetization/depacketization unit (not shown) may be included within the controller 110 and the second memory device 120_2 corresponding to both ends of the second I/F 140_2. The second I/F 140_2 may include a high-speed serial I/F, such as a peripheral component interconnect express (PCIe),

Accordingly, when a large amount of data is transmitted per unit of time, an overall data processing time may be reduced using the serial I/F. In contrast, when data access is intermittently performed by the host the data processing time can be reduced by reducing latency using the parallel I/F. In accordance with an embodiment of the present invention, an overall data processing time can be reduced by checking an access pattern of data by the host and exchanging data with a memory device based on an I/F suitable for the checked access pattern. This operation is described later in more detail with reference to the drawings.

The first and the second memory devices 120_1 and 120_2 of the memory system 110 may exchange data with the controller 110 through the first and the second I/Fs 140_1 and 140_2, respectively.

The first and second memory devices 120_1 and 120_2 may be different type memory devices. For example one may be a volatile memory device and the other may be a non-volatile memory device. The first memory device 120_1 may include a volatile memory device configured to exchange data with the controller 110 based on the first I/F 140_1 of a parallel I/F. The second memory device 120_2 may include a non-volatile memory device configured to exchange data with the controller 110 based on the second I/F 140_2 of a serial I/F. For example, the second memory device 120_2 may include flash memory and a flash memory controller. In accordance with an embodiment of the present invention, the flash memory controller may include the packetization/depacketization unit to depacketize/packetize data inputted and output through the second I/F 140_2, but the present invention is not limited thereto. In an embodiment, the second memory device 120_2 may include a RRAM, a PCRAM spin-transfer torque RAM (STT-RAM), and the like.

FIG. 2 illustrates an example configuration of the controller 110 of FIG. 1. Referring to FIG. 2, the controller 110 may include a pattern detection unit 210 and an address map configuration unit 220.

The controller 110 may store data in the first and second memory devices 120_1 and 120_2 (i.e., a write operation) or refer to data stored in the memory devices 120_2 and 120_2 (i.e., a read operation) in response to a request from the host. The host may have a tendency to sequentially read or write data. This is known as spatial locality of data. Furthermore, the host may have a tendency to access data that has been once accessed again within a relatively short time. This is known as a temporal locality of data,

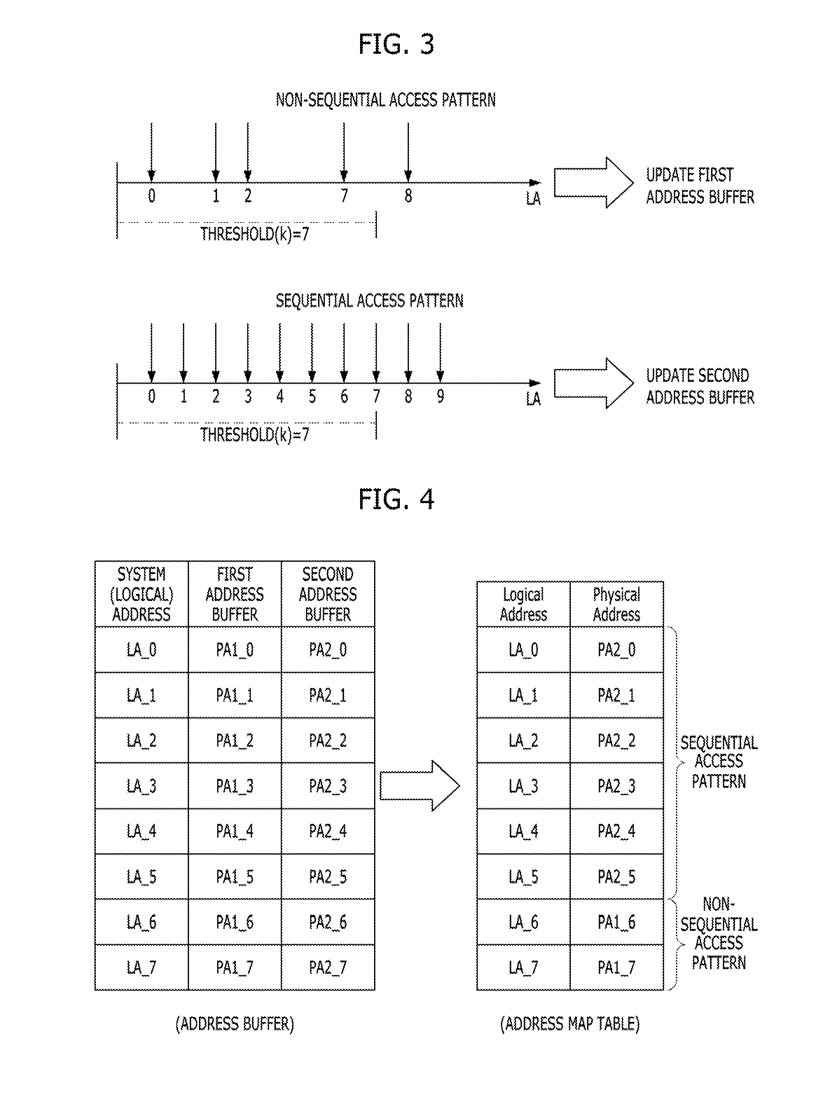

In accordance with an embodiment of the present invention, the pattern detection unit 210 of the controller 110 may detect a pattern of data to which access is requested by the host (hereinafter, referred to as an “access pattern”). For example, when an access operation from the host is performed on data corresponding to contiguous addresses greater than or equal to a threshold, the pattern detection unit 210 may detect the access pattern of the corresponding data as sequential access. When an access operation from the host is performed on data corresponding to discontiguous addresses or data corresponding to contiguous addresses less than the threshold, however, the pattern detection unit 210 may detect the access pattern of the corresponding data as non-sequential access. The operation of the pattern detection unit 210 is described in more detail with reference to FIG. 3.

The address map configuration unit 220 may map a logical address LA of data referred by the host to a physical address PA indicative of the locations of the first and second memory devices 120_1 and 120_2 in which the data has been actually stored, and manage the mapped address. Such mapping may be performed by storing the logical address LA of the data and the physical address PA corresponding to the logical address LA, in an address map table 2210. In accordance with the embodiment illustrated in FIG. 2, the address map configuration unit 220 may further include a first address buffer 2220 and a second address buffer 2230.

The controller 110 may store the same data in the first memory device 120_1 and the second memory device 120_2 until the access pattern is detected by the pattern detection unit 210. In this case, the address map configuration unit 220 may map the logical address LA of the data to a first physical address PA1 of the first memory device 120_1 in which the data has been stored, and store address mapping information on a mapping relation therebetween in the first address buffer 2220. Furthermore, the address map configuration unit 220 may map the logical address LA of the data to a second physical address PA2 of the second memory device 120_2 in which the data has been stored, and store address mapping information on a mapping relation therebetween in the second address buffer 2230.

Furthermore after the access pattern of the corresponding data is detected by the pattern detection unit 210, the>address map configuration unit 220 may update the address mapping information respectively stored in the first and the second address buffers 2220 and 2230 based on the detected access pattern of the data, and finally store the mapping of the logical address LA to the physical addresses PA in the address map table 2210.

When an access operation of the host is detected as being a non-sequential access, latency in each of the first and the second memory devices 120_1 and 120_2 can be reduced by processing the data based on a parallel I/F, that is, the first I/F 140_1. Accordingly, the address map table 2210 is updated based on the address mapping information stored in the first address buffer 2220 so that the data stored in the first memory device 120_1 may continue to be accessed through the first. I/F 140_1. In this case, the address mapping information stored in the second address buffer 2230 is invalidated so that the data stored in the second memory device 120_2 is no longer accessed. In contrast, when an access operation of the host is detected as being a sequential access, a large amount of the data may be processed at a time based on a serial I/F, that is, the second I/F 140_2. Accordingly, the address map table 2210 is updated based on the address mapping information stored in the second address buffer 2230 so that the data stored in the second memory device 120_2 may continue to be accessed through the second I/F 140_2. Likewise, the address mapping information stored in the first address buffer 2220 is invalidated so that the data stored in the first memory device 120_1 is no longer accessed. Thereafter, the controller 110 may process the data between the host and the first, and second memory devices 120_1 and 120_2 with reference to the address map table 2210.

FIG. 3 is a waveform illustrating an operation of the pattern detection unit 210 of FIG. 2.

Referring to FIG. 3, an operation for detecting an access pattern of data in response to an access operation of the host is provided. An X axis of FIG. 3 represents a logical address accessed by the host.

First, the pattern detection unit 210 may detect the access pattern based on a logical address of data to which access is requested by the host. When the host accesses a specific size of a contiguous address region, there is a high probability that the host may subsequently access the address region in a similar pattern. In contrast, when the host performs an access operation of a short length, a corresponding address may be subsequently accessed in a short pattern. Accordingly, when the access operation is performed on contiguous logical addresses having a size greater than or equal to a threshold value k, the pattern detection unit 210 may determine the access pattern of the data to be sequential access. When the access operation is performed on a logical address less than the threshold k, the pattern detection unit 210 may determine the access pattern of the data to be non-sequential access.

Data that is frequently used may be copied from the first and second memory devices 120_1 and 120_2 and may be stored in the cache memory (not shown) of the controller 110. The controller 110 may search the cache memory for corresponding data, copy the corresponding data from the first and second memory devices 120_1 and 120_2 to the cache memory when the corresponding data is not found in the cache memory (i.e., a cache miss), and uses the data stored in the cache memory. Such access to the first and second memory devices 120_1 and 120_2 may intermittently occur, and corresponding data may have a low bandwidth less than the threshold k, corresponding to a cache line, and may be detected in a non-sequential access pattern. In contrast, a data copy, data storage etc. for managing a specific region (e.g., a memory block) within the first and second memory devices 120_1 and 120_2 and arranging data of the region is a software operation and corresponding data may have a high bandwidth and may be detected in a sequential access pattern as corresponding to contiguous logical addresses.

The threshold k of the pattern detection unit 210 may be set to be greater than a data access size for a copy to the cache memory. FIG. 3 shows an example in which the threshold k has been set to “7”, but the present invention is not limited thereto.

Referring to an access pattern on the lower side of FIG. 3, the host accesses a contiguous address region that ranges from a logical address “0” to a logical address “9”, greater than the threshold k. Thus, the pattern detection unit 210 may determine such an access pattern to be a sequential access pattern. The address map configuration unit 220 may update the address map table 2210 with the address mapping information stored in the second address buffer 2230 based on the sequential access pattern, and may manage the updated address map table 2210. That is, only data that is stored in the second memory device 120_2 may be retained and accessed, and the data stored in the first memory device 120_1 may be invalidated.

In contrast, referring to an access pattern on the upper side of FIG. 3, a logical address region “0”, “1” and “2”, or “7” and “8” less than the threshold k was accessed. The pattern detection unit 210 may determine such an access pattern to be a non-sequential access pattern. The address map configuration unit 220 may update the address map table 2210 with the address mapping information stored in the first address buffer 2220 based on the non-sequential access pattern, and may manage the updated address map table 2210. That is, only data that is stored in the first memory device 120_1 may be retained and accessed, and the data stored in the second memory device 120_2 may be invalidated.

The pattern detection unit 210 may analyze the access pattern to an address region and accumulate the results of the analysis, thereby increasing accuracy. That is, the initial access pattern by the host may have relatively low accuracy. Accordingly, during a specific time frame, the controller 110 can store the same data in the first and the second memory devices 120_1 and 120_2, and the pattern detection unit 210 can secure the time taken to analyze data traffic between the host and the first and the second memory devices 120_1 and 120_2. Thereafter, the address map configuration unit 220 may update the address map table 2210.

FIG. 4 illustrates an operation of the address map configuration unit 220 of FIG. 2. FIG. 4 shows that address mapping information is stored in the first and the second address buffers 2220 and 2230, and the address map table 2210 is updated with the stored address mapping information.

Referring to FIG, 4, the controller 110 stores the same data in the first memory device 120_1 and the second memory device 120_2 until the pattern detection unit 210 detects an access pattern. Accordingly, the address map configuration unit 220 stores the address mapping information of the first and second memory devices 120_1 and 120_2 in which the data has been stored, in the first and the second address buffers 2220 and 2230, respectively. FIG. 4 shows that data corresponding to first to eighth logical addresses LA_0 to LA_7 has been stored in the first to the eighth physical addresses PA1_0 to PA1_7 of the first memory device 120_1, respectively, and the first to the eighth physical addresses PA2_0 to PA2_7 of the second memory device 120_2, respectively.

Thereafter, the pattern detection unit 210 may analyze data traffic between the host and the first and the second memory devices 120_1 and 120_2 for a specific time frame and may consequentially detect the access pattern of the data corresponding to the first to the eighth logical addresses LA_0 to LA_7. For example, the pattern detection unit 210 may detect that the host has performed sequential access on the region of the first to the sixth logical addresses LA_{—} O to LA_5 and that the host has performed non-sequential access on the region of the seventh and the eighth logical addresses LA_6 and LA_7.

Accordingly, a data exchange based on a serial I/F may be performed on the region of the first to the sixth logical addresses LA_0 to LA_5 on which the sequential access is performed by the host so that a large amount of data within the region is processed at a time for reducing a total data processing time. As a result, the data stored in the first memory device 120_1 is invalidated, and the data stored in the second memory device 120_2 is accessed. That is, the address map table 2210 is updated with the address mapping information stored in the second address buffer 2230. Accordingly, the first to the sixth logical addresses LA_0 to LA_5 may be mapped to the first to the sixth physical addresses PA2_0 to PA2_5 of the second memory device 120_2.

In contrast, a data exchange based on a parallel I/F may be performed on the region of the seventh and the eighth logical addresses LA_6 and LA_7 to which the non-sequential access is performed by the host for reducing latency by obviating overhead attributable to the serialization. Hence, the data stored in the first memory device 120_1 is accessed, while the data stored in the second memory device 120_2 is invalidated. That is, the address map table 2210 is updated with the address mapping information stored in the first address buffer 2220. Accordingly, the seventh and the eighth logical addresses LA_6 and LA_7 may be mapped to the seventh and the eighth physical addresses PA1_6 and PA1_7 of the first memory device 120_1.

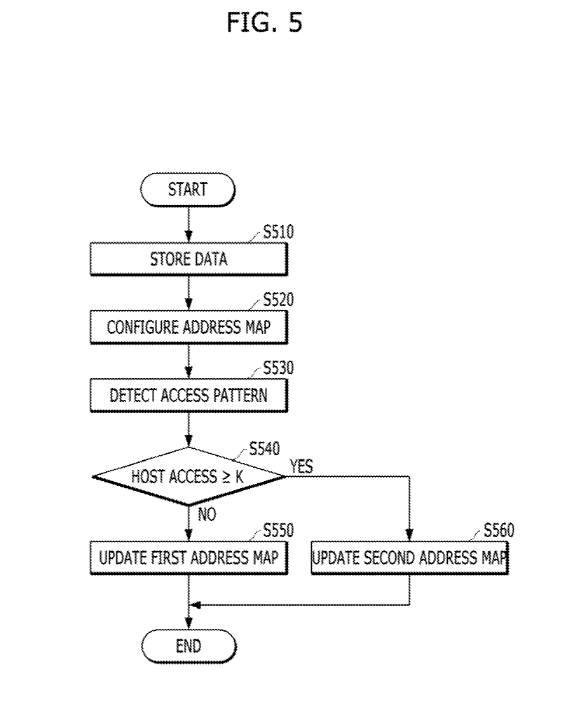

An overall operation of the memory system described with reference to FIGS. 1 to 4 is described below with reference to FIG. 5.

FIG. 5 illustrates an overall operation of a memory system, according to an embodiment of the present invention.

1) Store data (S510)

First, in step S510, the controller 110 of the memory system 100 may store data accessed by the host HOST, in the memory devices 120_1 and 102_2. That is, in an initial operation until the access pattern of the data accessed by the host is detected, the controller 110 stores the same data in the first and the second memory devices 120_1 and 102_2.

2) Configure address map (S520)

Then in step S520, the address map configuration unit 220 of the controller 110 configures address mapping information on the data stored in the first and the second memory devices 120_1 and 102_2. That is, the address map configuration unit 220 may store the address mapping information on the data stored in the first memory device 120_1, in the first address buffer 2220, and may store the address mapping information on the data stored in the second memory device 120_2 in the second address buffer 2230. In this case, the address mapping information on the data may be configured using the mapping relation between the logical address of the data accessed by the host and a physical address indicative of the location in which the data has been stored.

3) Detect access pattern (S530 & S540)

In step S530, the pattern detection unit 210 of the controller 110 may detect the access pattern of the data stored in the first and the second memory devices 120_1 and 102_2, based on the access operation of the host. That is, the pattern detection unit 210 determines whether the host accesses a contiguous logical address region of a specific value or more based on the logical address of the data requested by the host. When it is determined that the host accesses a contiguous logical address region greater than or equal to a threshold value k (≧k) (“YES” in Step S540), the pattern detection unit 210 may determine the access pattern to be sequential access. When it is determined that the host accesses a logical address region less than the threshold value k (<k) (“NO” in Step S540), the pattern detection unit 210 may determine the access pattern to be non-sequential access.

4) Update first or second address map (S550 & S560)

When the non-sequential access pattern is detected (“NO” at Step S540), a first address map is updated with corresponding data. That is, in Step S550 the address map table 2210 may be updated based on the address mapping information stored in the first address buffer 2220. In this case, the address mapping information stored in the second address buffer 2230 may be invalidated. In contrast, when the sequential access pattern is detected (“YES” in Step S540), a second address map is updated with corresponding data. That is, the address map table 2210 may be updated based on the address mapping information stored in the second address buffer 2230, and the address mapping information stored in the first address buffer 2220 may be invalidated.

As described above, in case where data is transmitted through a serial I/F, the processing time of a processor can be reduced by transmitting the data at high speed if the amount of the data to be transmitted per unit time is large. However, when memory access that requires a short standby time is intermittently processed, a reduction in the processing time of a processor through the improvement of a bandwidth may not be expected because a response time is slow compared to a parallel I/F due to overhead attributable to packetization/depacketization. In contrast, in the case where data is transmitted through a parallel I/F, there may be a performance bottleneck when a large amount of data is transmitted per unit time because a maximum throughput has been determined.

Hence, in accordance with an embodiment of the present invention, a hybrid memory system is provided that exhibits improved performance. Specifically, performance of the hybrid memory system is optimized by employing two memory interfaces in parallel and selectively using one or the other depending on a characteristic access pattern of the data. The two memory interfaces include an I/F suitable for an access pattern having a relatively high bandwidth or long latency and an I/F suitable for an access pattern having a relatively low bandwidth or short latency. That is, the address map of data can be managed so that the data is processed through a suitable serial or parallel I/F depending on a characteristic (i.e., a bandwidth or latency) of the data requested by a host that accesses a memory device.

In accordance with the memory system according to the aforementioned embodiments, the access pattern of data inputted to and outputted from memory devices through a plurality of I/Fs is detected, and the address map of the data is managed based on the detected access pattern. Accordingly, the data processing time of the memory system can be reduced by processing data using an I/F suitable for an access detected pattern of the data.

Although various embodiments have been described for illustrative purposes, it will be apparent to those skilled in the art that various changes and modifications may be made without departing from the spirit and scope of the invention as defined in the following claims.

What is claimed is:

1. A memory system comprising:
a first memory device suitable for inputting and outputting data through a serial interface;
a second memory device suitable for inputting and outputting the data through a parallel interface; and
a controller suitable for detecting an access pattern of the data, selecting one of the first and the second memory devices based on the detected access pattern, and controlling the selected memory device to store the data.

2. The memory system of claim wherein the controller is suitable for:
detecting the access pattern of the data as a sequential access pattern when access to contiguous logical addresses greater than or equal to a threshold by a host is checked and
detecting the access pattern of the data as a non-sequential access pattern when access to contiguous logical addresses less than the threshold or to a discontiguous logical address by the host is checked.

3. The memory system of claim 2, wherein the controller is suitable for:
selecting the first memory device when the access pattern of the data is detected as the sequential access pattern, and
selecting the second memory device when the access pattern of the data is detected as the non-sequential access pattern.

4. The memory system of claim 2, wherein the controller comprising:
first and second address buffers suitable for storing address mapping information of the data stored in the first and the second memory devices, respectively;
a pattern detection unit suitable for detecting the access pattern of the data; and
an address map table suitable for being updated with the address mapping information stored in the first and the second address buffers based on the access pattern detected by the pattern detection unit.

5. The memory system of claim 4, wherein, when the access pattern of the data is detected as the sequential access pattern, the controller is suitable for updating the address map table with the address mapping information stored in the first address buffer and invalidating the address mapping information stored in the second address buffer.

6. The memory system of claim 4, wherein, when the access pattern of data is detected as the non-sequential access pattern, the controller is suitable for updating the address map table with the address mapping information stored in the second address buffer and invalidating the address mapping information stored in the first address buffer.

7. The memory system of claim 4, wherein the controller is suitable for controlling both the first and the second memory devices to store the data until the pattern detection unit detects the access pattern of the data.

8. The memory system of claim 1, wherein the controller is suitable for:
analyzing the access pattern of the data for a specific time frame,
accumulating analysis results, and
detecting the access pattern of the data

9. The memory system of claim 1, wherein the first and the second memory devices comprise a non-volatile memory device and a volatile memory device, respectively

10. The memory system of claim 1, herein the controller and the first memory device are suitable for:
packetizing data to be outputted to the serial interface along with a corresponding command and address, and
depacketizing data received from the serial interface.

11. A memory system comprising:
a first memory device suitable for inputting and outputting data through a serial interface;
a second memory device suitable for inputting and outputting the data through a parallel interface; and
a controller suitable for configuring address mapping information of the data stored in the first and the second memory devices,
wherein the controller is suitable for detecting an access pattern of the data for a specific time frame and performing an update on the address mapping information based on the detected access pattern.

12. The memory system of claim 11, wherein the controller is suitable for:
detecting the access pattern of the data as a sequential access pattern when access to contiguous logical addresses greater than or equal to a threshold by a host is checked, and
detecting the access pattern of the data as a non-sequential access pattern when access to contiguous logical addresses less than the threshold or to a discontiguous logical address by the host is checked.

13. The memory system of claim 12, wherein the controller comprising:
first and second address buffers suitable for storing the address mapping information of the data stored in the first and the second memory devices, respectively;
a pattern detection unit suitable for detecting the access pattern of the data; and
an address map table suitable for being updated with the address mapping information stored in the first and the second address buffers based on the access pattern detected by the pattern detection unit.

14. The memory system of claim 13, wherein, when the access pattern of the data is detected as the sequential access pattern, the controller is suitable for updating the address map table with the address mapping information stored in the first address buffer and invalidating the address mapping information stored in the second address buffer.

15. The memory system of claim 13, wherein, when the access pattern of data is detected as the non-sequential access pattern, the controller is suitable for updating the address map table with the address mapping information stored in the second address buffer and invalidating the address mapping information of the data stored in the first address buffer.

16. An operating method of a memory system comprising:
storing data in a first memory device by sending the data through a serial interface, and storing the data in a second memory device by sending the data through a parallel interface:
configuring address mapping information of the data stored in the first and the second memory devices;
detecting an access pattern of the data; and
performing an update on the address mapping information based on the detected access pattern.

17. The operating method of claim 16, wherein the detecting of the access pattern of the data comprises:
detecting the access pattern of the data as a sequential access pattern in response to access to contiguous logical addresses greater than or equal to a threshold; and
detecting the access pattern of the data as a non-sequential access pattern in response to access to contiguous logical addresses less than the threshold or to a discontiguous logical address.

18. The operating method of claim 17, wherein the performing of the update on the address mapping information based on the detected access pattern when the access pattern of the data is detected as the sequential access pattern comprises:
updating the address mapping information of the data stored in the first memory device; and
invalidating the address mapping information of the data stored in the second memory device.

19. The operating method of claim 17, wherein the performing of the update on the address mapping information based on the detected access pattern when the access pattern of the data is detected as the non-sequential access pattern comprises:
updating the address mapping information of the data stored in the second memory device; and
invalidating the address mapping information of the data stored in the first memory device.

20. The operating method of claim 17, wherein:
the sequential access pattern comprises a data access pattern for arranging data of memory blocks in the fiat and second memory devices, and
the non-sequential access pattern comprises a data access pattern for copying data from the first and second memory devices to a cache memory.
